(19) United States
(12) Patent Application Publication
(10) Pub. No.: US 2006/0292976 A1
(43) Pub. Date: Dec. 28, 2006

(54) Cord and cordless vent air conditioner

(76) Inventor: Gregory Andrew Sales, Norfolk, VA (US)

Correspondence Address: Gregory Sales, 1835 Cheek Rd. Apt. 16-F, Durham, NC, 27704, US

(21) Appl. No.: 11/134,677

(22) Filed: May 23, 2005

(51) Int. Cl. E06B 7/02; F24F 7/00

(52) U.S. Cl. 454/196

(57) ABSTRACT

The cordless vents are attached to charger circuitry system built on window and split units. They detach from charger and can go throughout the home. They are three feet long and have fan and thermostat to circulate air. The cordless vents have five inch hoses connected to regular vents. These rectangular extended vents circulate air through vents to cool rooms. The split have vents that come out of the wall and will go a number of feet to cool places that you want throughout your home, and even patio decks ect. The soul purpose of this unit called the cord and cordless vent air conditioner is to be able to to carry vents to any where you would like to, in order to cool places that can't be cooled by single units. These vents can be carried with a horse or they can be cordless.

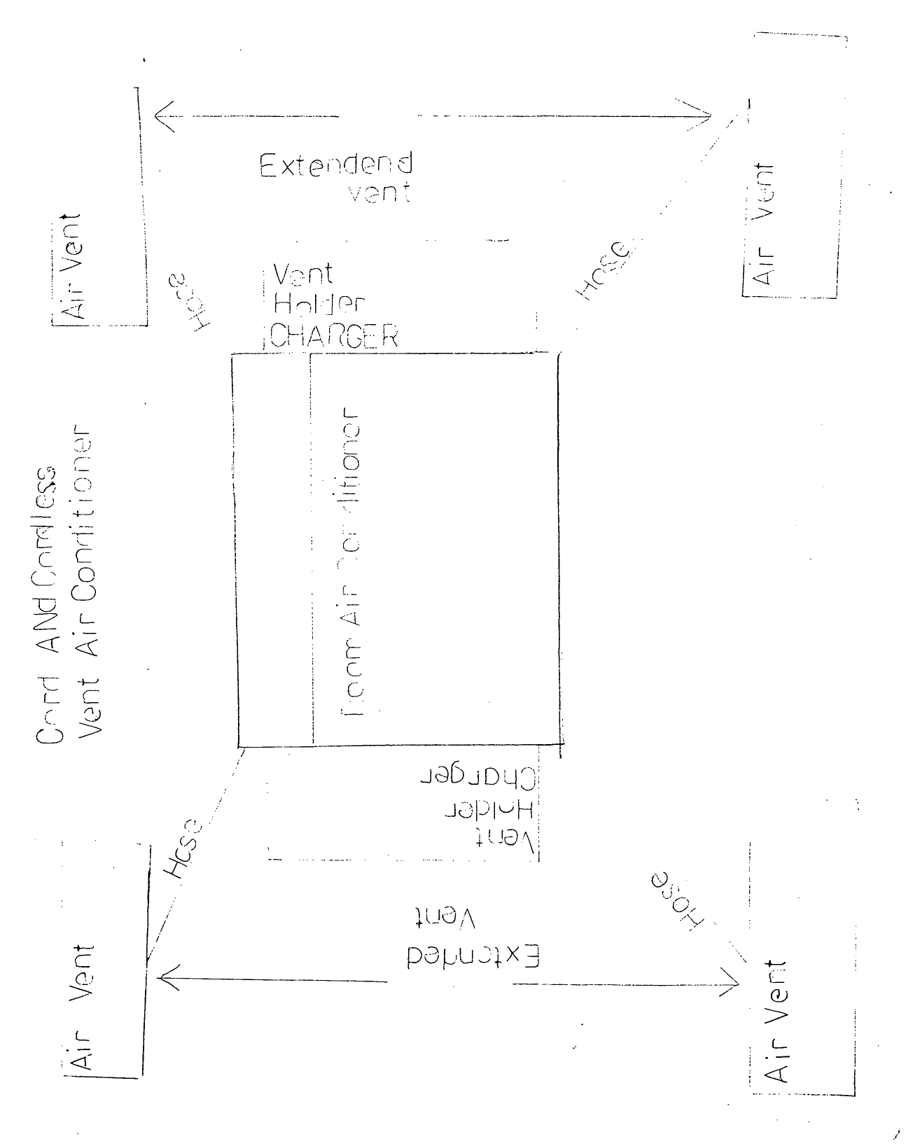

Specifications for cordless vent air conditioner

1. Six inch hose with vent

2. Vent charging unit

3. Cordless vent with built in thermostat

4. Vent with super turning fan

5. Built in stand to hold vent

6. Vent with lights

7. Inferred remote signal to operate vent

8. Ventilation lever

9. 20 amp circuitry system

10. 250 v 3 prong grounding receptable

11. Air filter

12. Compressor

13. Evaporator

1. I claim vents charging reception and input and output connections built on vent And built on charging units of window and split air conditioners new cordless Systems.

2. I claim air circulations built inside of cordless vents and hoses electrical or Turning motions. Air created by electricity only or fan.

3. I claim cordless and extended vents attachments to window and split air Conditioners, such as hose to extend air into other rooms and it's attachments to systems itself for blowing air into hose to reach other rooms and even to be built inside of tent air conditioners for heat and air called built in tent air conditioners.
